(19) United States
(12) Patent Application Publication
(10) Pub. No.: US 2026/0158909 A1
(43) Pub. Date: Jun. 11, 2026

(54) IN-VEHICLE DISPLAY APPARATUS

(71) Applicant: Faurecia Clarion Electronics (Xiamen) Co., Ltd., Xiamen (CN)

(72) Inventors: Depeng GAN, Xiamen (CN); Yuanwen YE, Xiamen (CN); Mo SHANG, Xiamen (CN); Conghuai XIE, Xiamen (CN); Yuanning PAN, Xiamen (CN); Zhenxiong TANG, Xiamen (CN); Huoyan RAO, Xiamen (CN)

(73) Assignee: Faurecia Clarion Electronics (Xiamen) Co., Ltd., Xiamen (CN)

(21) Appl. No.: 19/411,458

(22) Filed: Dec. 8, 2025

(30) Foreign Application Priority Data
Dec. 11, 2024 (CN) 202411822774.2

(51) Int. Cl. B60K 35/22

(52) U.S. Cl. CPC B60K 35/22; B60K 2360/33; B60K 2360/692; B60K 2360/693

(57) ABSTRACT

The in-vehicle display apparatus includes a cover plate; a support member, located on one side of the cover plate; a first adhesive layer, located between the cover plate and the support member, one side of the first adhesive layer is connected to the cover plate, and another side of the first adhesive layer is connected to the support member, an avoidance opening is disposed on the first adhesive layer, and the support member, the first adhesive layer and the cover plate enclose an accommodating space; a display screen module, disposed in the accommodating space and only connected to the cover plate; a backlight module, connected to the support member, and located on one side of the support member away from the display screen module; and a rear cover, connected to the support member.

### CROSS REFERENCE TO RELATED APPLICATION(S)

The present disclosure is filed based on Chinese Patent Application with the application No. 202411822774.2, filed on Dec. 11, 2024, and claims priority to the Chinese Patent Application, the entire content of the Chinese Patent Application is incorporated herein by reference.

### TECHNICAL FIELD

The present disclosure relates to the field of vehicle technologies, and in particular, to an in-vehicle display apparatus.

### BACKGROUND

Currently, most vehicles are equipped with in-vehicle display apparatuses, and the in-vehicle display apparatuses may present contents, such as text, images, and videos to users. For example, the in-vehicle display apparatuses may present navigation-related information to facilitate drivers in navigating vehicles according to navigation information.

### SUMMARY

The present disclosure provides an in-vehicle display apparatus, the in-vehicle display apparatus includes a cover plate, a support member, a display screen module, a first adhesive layer, a backlight module, and a rear cover. The support member is located on one side of the cover plate and is connected to the cover plate. The first adhesive layer is located between the cover plate and the support member, and one side of the first adhesive layer is connected to the cover plate and another side of the first adhesive layer is connected to the support member. An avoidance opening is disposed on the first adhesive layer, and the support member, the first adhesive layer and the cover plate enclose an accommodating space. The display screen module is disposed in the accommodating space and is only connected to the cover plate. The backlight module is connected to the support member, and is located on one side of the support member away from the display screen module. The rear cover is connected to the support member.

In some embodiments, a surface of one side of the support member close to the cover plate is provided with a first accommodating groove, and the display screen module is disposed in the first accommodating groove.

In some embodiments, the in-vehicle display apparatus further includes a second adhesive layer. The second adhesive layer is disposed between the display screen module and the cover plate, and one side of the second adhesive layer is bonded to the display screen module and another side of the second adhesive layer is bonded to the cover plate.

In some embodiments, a length of the support member is greater than or equal to a length of the cover plate.

In some embodiments, a width of the support member is greater than or equal to a width of the cover plate.

In some embodiments, one side of the support member away from the cover plate is provided with a connecting groove, and the backlight module is inserted into the connecting groove.

In some embodiments, a limiting portion is disposed within the connecting groove, and the backlight module is detachably connected to the limiting portion.

In some embodiments, the limiting portion is a limiting groove, and the limiting groove is disposed on a peripheral wall of the connecting groove. The backlight module includes a backlight module body and a clamping portion. The backlight module body is inserted into the connecting groove. The clamping portion is disposed on a peripheral side of the backlight module and clamped with the limiting groove.

In some embodiments, a protective cavity having an opening is disposed on the rear cover, and the backlight module is located on one side of the support member close to a bottom wall of the protective cavity.

In some embodiments, a connecting portion is disposed on the support member, and an avoidance hole is disposed on the rear cover. The in-vehicle display apparatus also includes a mounting member, and the mounting member is penetrated through the avoidance hole, and one end of the mounting member is connected to the connecting portion and another end of the mounting member is connected to the rear cover.

In some embodiments, a clamping member is disposed on the support member, a clamping groove is disposed on the rear cover, and the clamping member is clamped in the clamping groove.

### BRIEF DESCRIPTION OF THE DRAWINGS

FIG. 1 is a first schematic diagram of a structure of an in-vehicle display apparatus, provided by the embodiments of the present disclosure.

FIG. 2 is a second schematic diagram of a structure of an in-vehicle display apparatus, provided by the embodiments of the present disclosure.

FIG. 3 is a third schematic diagram of a structure of an in-vehicle display apparatus, provided by the embodiments of the present disclosure.

FIG. 4 is a schematic diagram of a partial structure of an in-vehicle display apparatus, provided by the embodiments of the present disclosure.

### REFERENCE SIGNS

100—in-vehicle display apparatus; 1—cover plate; 2—support member; 21—clamping member; 22—first accommodating groove; 231—connecting groove; 232—limiting portion; 24—threaded hole; 3—display screen module; 4—backlight module; 41—backlight module body; 42—clamping portion; 5—rear cover; 51—protective cavity; 6—second adhesive layer; 7—first adhesive layer; 71—avoidance opening; 8—bolt.

### DETAILED DESCRIPTION

The technical solutions in the embodiments of the present disclosure will be described clearly and completely below in conjunction with the drawings in the embodiments of the present disclosure, and it is obvious that the described embodiments are only a part of the embodiments of the present disclosure, but not all of the embodiments. Based on the embodiments in the present disclosure, all other embodiments obtained by those ordinary skilled without creative efforts shall fall within the protection scope of the present disclosure.

In the description of the present disclosure, it should be understood that, orientations or positional relationships indicated by the terms such as “top”, “bottom”, “left”, “right”, “front”, “back”, “inner”, “outer” and “center” and the like are based on orientations or positional relationships shown in the drawings, which are merely for convenience in description of the present disclosure and simplifying the description, but are not to indicate or imply that the indicated apparatuses or elements must have a particular orientation, or must be constructed and operated in a particular orientation, therefore, it cannot be understood as a limitation on the present disclosure.

Hereinafter, terms such as “first” and “second”, etc., are used for descriptive purposes only, but cannot be understood to indicate or imply the relative importance or implicitly indicate the number of the indicated technical features. Thus, features defined with “first” or “second”, etc., may explicitly or implicitly include one or more such features.

In the description of the present disclosure, unless otherwise specified, the symbol “/” means “or”, and for example, A/B may represent A or B. Herein, “and/or” is only used to describe an associated relationship between associated objects, representing that there may be three relationships, and for example, A and/or B may represents three cases: only A, A and B, and only B. Additionally, “at least one” means one or more, and “multiple/plurality of” means two or more.

In the embodiments of the present disclosure, the terms “comprise/include,” “contain,” or any other variations thereof are intended to cover a non-exclusive inclusion, such that a process, a method, an article, or an apparatus that includes a list of elements not only includes those elements but also other elements not expressly listed, or elements inherent to such a process, a method, an article, or an apparatus. Without further limitations, an element defined by the phrase “comprising one . . . /including one . . . ” does not exclude the presence of additional identical elements in the process, method, article, or apparatus that includes the element.

In the embodiments of the present disclosure, the words, such as “exemplary/exemplarily” or “for example”, are used to represent an example, an illustration or an explanation. Any embodiment or design solution described with “exemplary/exemplarily” or “for example” in the embodiments of the present disclosure should not be construed as preferred or advantageous over other embodiments or design solutions. Rather, the usage of the words, such as “exemplary/exemplarily” or “for example”, is intended to present relevant concepts in a specific manner.

In-vehicle display apparatuses in related technologies generally include a display module, a cover plate, and a rear cover. An installation groove for accommodating the display module is disposed on the rear cover. The display module generally contains a display screen module and a backlight module.

In the process of assembling the in-vehicle display apparatus, workers usually first connect a display screen module and a backlight module together to form a display module, and then connect the display module to the cover plate with special adhesive to form a playback module and finally, connect the playback module to the rear cover.

When the playback module is connected to the rear cover, the display screen module and the backlight module are located in the mounting groove, and the cover plate is covered over a groove opening of the mounting groove and bonded to the rear cover.

Due to certain processing errors in the thickness of the display screen and backlight module, and the cover plate and display screen module are connected by adhesive, the thickness of the adhesive layer also has certain errors. When the protective cover plate, display screen, and backlight module are connected together, an overall thickness may exceed a designed thickness.

Thus, when the display screen module and the backlight module are inserted into the mounting groove on the rear cover, when the backlight module abuts against the bottom of the mounting groove, there may be a certain gap between the cover plate and the rear cover. After the cover plate and the rear cover are bonded together, the connection between the cover plate and the rear cover will undergo a certain deformation, which causes the cover plate to have a reaction force in the direction away from the rear cover, making it easy for the connection between the cover plate and the rear cover to separate.

Based on this, the embodiments of the present disclosure provide an in-vehicle display apparatus 100, as shown in FIG. 1. FIG. 1 is a first schematic diagram of a structure of an in-vehicle display apparatus 100, provided by the embodiments of the present disclosure. The in-vehicle display apparatus 100 may include a cover plate 1, a support member 2, a first adhesive layer 7, and a display screen module 3. The support member 2 is located on one side of the cover plate 1. The first adhesive layer 7 is located between the cover plate 1 and the support member 2. One side of the first adhesive layer 7 is connected to the cover plate 1 and another side of the first adhesive layer 7 is connected to the support member 2. An avoidance opening 71 is disposed on the first adhesive layer 7. The support member 2, the first adhesive layer 7, and the cover plate 1 enclose an accommodating space, and the display screen module 3 is disposed in the accommodating space and is only connected to the cover plate 1.

In the actual application process, the first adhesive layer 7 may bond the cover plate 1 to the support member 2, thereby connecting the cover plate 1 and the support member 2 together so that the support member 2 may provide support for the cover plate 1. The accommodating space enclosed by the support member 2, the first adhesive layer 7, and the cover plate 1 may provide a setting position for the display screen module 3, thereby fixing the position of the display screen module 3.

Since an avoidance opening 71 is disposed on the first adhesive layer 7, in the actual application process, the avoidance opening 71 may provide avoidance for the display screen module 3 so that the display screen module 3 may be connected to the cover plate 1.

It can be understood that, the display screen module 3 may display graphic and text information to the user. In addition, the display screen module 3 may also integrate touch sensing functionality so that users can interact with the in-vehicle display apparatus 100.

As shown in FIG. 1, the in-vehicle display apparatus 100 may further include a backlight module 4. The backlight module 4 may provide a light source for the display screen module 3 so that the display screen module 3 may obtain uniform and sufficient brightness, making the images on the display screen module 3 clearly visible.

Continuing to refer to FIG. 1, the backlight module 4 is connected to the support member 2 and is located on one side of the support member 2 away from the display screen module 3.

In the actual application process, the backlight module 4 is connected to the support member 2 and is located on one side of the support member 2 away from the display screen module 3. Thus, a thickness error of the backlight module 4 does not affect the connection between the cover plate 1 and the support member 2. The connection between the cover plate 1 and the support member 2 is only affected by the thickness of the display screen module 3. Compared with the traditional connection manner, the connection between the cover plate 1 and the support member 2 is less affected by factors.

During the assembly of the in-vehicle display apparatus 100 by the worker, when an actual thickness of the display screen module 3 and the backlight module 4 is larger than a standard thickness, compared with a traditional connection manner, the cover plate 1 in the solutions of the present disclosure is only affected by the error of the display screen module 3, and a gap between the cover plate 1 and the support member 2 is smaller. Correspondingly, a deformation of the cover plate 1 after it is connected to the support member 2 is small, and reaction force generated by the deformation of the cover plate 1 is also small, making it difficult for the connection between the cover plate 1 and the support to separate.

Continuing to refer to FIG. 1, the in-vehicle display apparatus 100 may also include a rear cover 5. The rear cover 5 is connected to the support member 2. In the actual application process, the rear cover 5 may be connected to a mounting structure on the vehicle. Thus, after the support member 2 is connected to the rear cover 5, the support member 2 and components such as the cover plate 1, display screen module 3, backlight module 4, etc., connected to the support member 2 may be fixed on the vehicle body.

In the actual application process, the first adhesive layer 7 is located between the cover plate 1 and the support member 2. Thus, the first adhesive layer 7 may be connected only to the one side of the support member 2 and the cover plate 1 that are close to each other, and the first adhesive layer 7 does not extend to the peripheral wall of the cover plate 1 or the support member 2. Correspondingly, the rear cover 5 does not need to have a structure on the peripheral side of the display screen module 3 for connecting with the first adhesive layer 7, which may reduce a thickness of a frame on the peripheral side of the display screen module 3, thereby achieving an effect of a narrow bezel.

Exemplarily, the first adhesive layer 7 may be made of a high adhesive-property double-sided tape. Thus, the first adhesive layer 7 may have sufficient adhesive strength. Meanwhile, the high adhesive-property double-sided tape also has excellent weather resistance, good impact resistance and vibration resistance, which may prevent the cover plate 1 and the support member 2 from separating from each other due to vibrations generated during vehicle operation.

It can be understood that, compared with the existing solutions of connecting the cover plate and the rear cover, the connection between the cover plate 1 and the support member 2 in the present disclosure is less affected by factors, and the reaction force on the cover plate 1 is less. Correspondingly, when designing the cover plate 1 and the support member 2, a bonding area between the cover plate 1 and the support member 2 may be appropriately reduced, thereby reducing a bezel size of the support member 2 on the peripheral side of the display screen module 3, so as to achieve the design effect of a narrow bezel. Thus, a screen ratio of the in-vehicle display apparatus 100 is relatively large, which may improve the user experience.

Furthermore, the display screen module 3 of the present disclosure is disposed within the accommodating space enclosed by the support member 2, the cover plate 1, and the first adhesive layer 7, rather than within the accommodating space formed by a rear cover in the prior art. The rear cover 5 of the present disclosure does not need to have a structure for connecting with the display screen module 3, which may reduce an edge thickness of the rear cover and thus achieve the effect of a narrow bezel.

In some embodiments, as shown in FIG. 1, the length of the support member 2 may be greater than or equal to the length of the cover plate 1. In the actual application process, after the cover plate 1 and the support member 2 are connected together, the cover plate 1 does not exceed the support member 2 in a length direction. Thus, along the length direction of the in-vehicle display apparatus 100, there is no need to reserve a structure for connecting to the cover plate 1 on the rear cover 5, which may facilitate the narrow bezel design of the in-vehicle display apparatus 100 in the length direction.

In some embodiments, as shown in FIG. 1, the width of the support member 2 may be greater than or equal to the width of the cover plate 1. In the actual application process, after the cover plate 1 and the support member 2 are connected together, the cover plate 1 does not exceed the support member 2 in a width direction. Thus, along the width direction of the in-vehicle display apparatus 100, there is no need to reserve a structure for connecting to the cover plate 1 on the rear cover 5, which may facilitate the narrow bezel design of the in-vehicle display apparatus 100 in the width direction.

In some embodiments, as shown in FIG. 1, a protective cavity 51 having an opening is disposed on the rear cover 5, and the backlight module 4 is located on one side of the support member 2 close to a bottom wall of the protective cavity 51. In the actual application process, the backlight module 4 may be inserted into the protective cavity 51, and the protective cavity 51 may protect the backlight module 4.

Since the backlight module 4 is located on the one side of the support member 2 close to the bottom wall of the protective cavity 51, the display screen module 3 and the cover plate 1 may be located on one side of the support member 2 facing an opening of the protective cavity 51. Thus, the rear cover 5 does not affect the display screen module 3 from showing users graphic and text information.

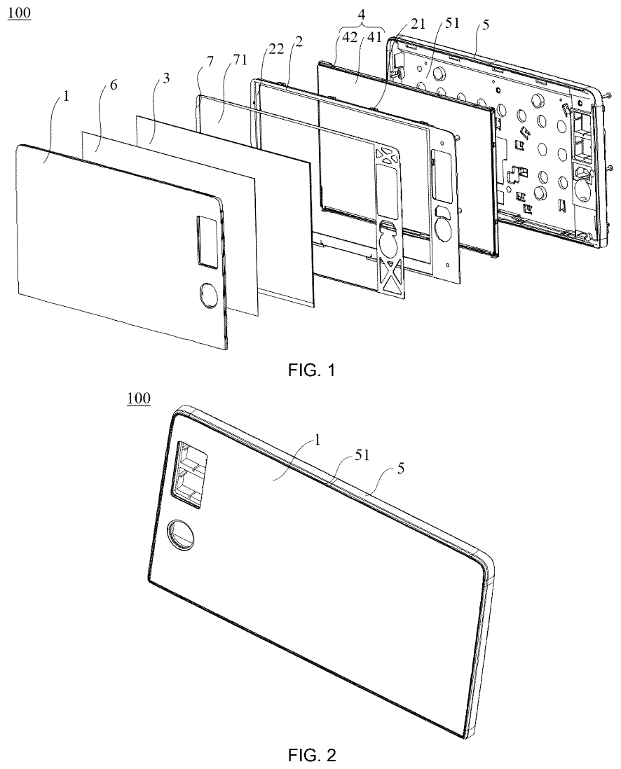

Exemplarily, as shown in FIG. 2, FIG. 2 is a second schematic diagram of a structure of an in-vehicle display apparatus 100, provided by the embodiments of the present disclosure. The mounting member 2 (as shown in FIG. 1) may be inserted into the protective cavity 51, and the protective cavity 51 may provide protection for the components located therein.

In some embodiments, the support member 2 may be cover over the opening of the protective cavity 51. Thus, an edge of the rear cover 5 does not extend to one side of the support member 2 close to the cover plate 1, which may reduce the bezel of the peripheral side of the cover plate 1 to achieve the effect of a narrow bezel.

In some embodiments, a connecting portion may be disposed on the support member 2, and a position corresponding to the rear cover 5 may be provided with an avoidance hole. The in-vehicle display apparatus 100 may also include a mounting member, and the mounting member is penetrated through the avoidance hole, and one end of the mounting member is connected to the connecting portion and another end of the mounting member is connected to the rear cover 5. Thus, the rear cover 5 may be connected to the support member 2 through the mounting member.

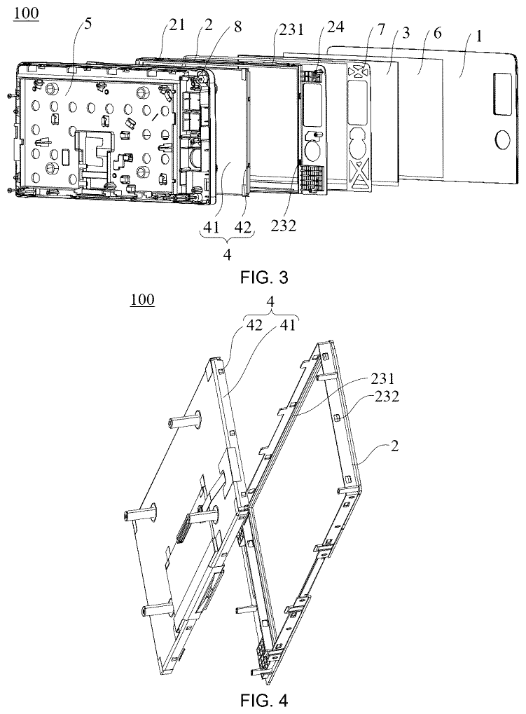

Exemplarily, as shown in FIG. 3, FIG. 3 is a third schematic diagram of a structure of an in-vehicle display apparatus 100, provided by the embodiments of the present disclosure. The support member 2 may protrude in the direction close to the rear cover 5 to form a connecting portion, and a threaded hole 24 may be disposed on the connecting portion. A connecting groove is formed by protruding from the rear cover 5 in a direction away from the support member 2, and the connecting portion is inserted into the connecting groove. The connecting groove is provided with an avoidance hole. The mounting member may be a bolt 8, the bolt 8 is penetrated through the avoidance hole and is threadedly connected to the threaded hole 24. The end of the bolt 8 abuts against one side of the connecting groove away from the support member 2, so that the rear cover 5 is connected to the support member 2.

Thus, the stability of the connection between the support member 2 and the rear cover 5 may be ensured. Furthermore, by removing the bolt 8, the workers may separate the support member 2 from the rear cover 5, making it easier for them to repair the backlight module 4 and the display screen module 3.

It can be understood that, the extension direction of the threaded hole 24 may be perpendicular to the rear cover 5. Thus, when the workers insert the bolt 8 into the threaded hole 24, the workers have a relatively large operating space, making the installation more convenient.

In some embodiments, as shown in FIG. 3, a clamping member 21 is disposed on the support member 2, a clamping groove is disposed on the rear cover 5, and the clamping member is clamped in the clamping groove. Thus, the support member 2 may also be connected to the rear cover 5.

In some embodiments, as shown in FIG. 3, a plurality of clamping members 21 may be disposed on the one side of the support member 2 close to the bottom wall of the protective cavity 51 (as shown in FIG. 1). Correspondingly, a plurality of clamping grooves may be disposed on side walls and bottom walls of the protective cavity 51. The clamping member 21 may be clamped in the clamping groove, thereby connecting the support component 2 and the rear cover 5 together.

It can be understood that, in the actual application process, both the clamping member 21 and the connecting portion may be disposed on the support member 2, or one of them may be disposed on the support member 2. Correspondingly, the rear cover 5 may be adjusted according to the structure disposed on the support member 2 to ensure that the two may be adapted to each other.

In some embodiments, the disposed direction of both the clamping member 21 and the clamping groove may be perpendicular to the rear cover 5. Thus, this makes it easier for workers to connect the rear cover 5 to the support member 2.

It should be noted that, in the actual application process, the rear cover 5 may also be connected to the support member 2 in other ways, as long as the stability of the rear cover 5 and the support member 2 when connected together is ensured. Exemplarily, the rear cover 5 may also be connected to the support member 2 by adhesive bonding.

In some embodiments, as shown in FIG. 1, a surface of one side of the support member 2 close to the cover plate 1 is provided with a first accommodating groove 22, and the display screen module 3 is disposed in the first accommodating groove 22.

In the actual application process, the first accommodating groove 22 may serve as an accommodating space to form an avoidance space for the display screen module 3. Thus, the worker may dispose the display screen module 3 in the first accommodating groove 22, so that one side of the cover plate 1 close to the support member 2 may fit with the surface of the support member 2, so that the worker may connect the cover plate 1 and the support member 2 together.

In the actual application process, after the display screen module 3 is inserted into the first accommodating groove 22, the first accommodating groove 22 may form a limitation on the peripheral side of the display screen module 3, thereby limiting the position of the display screen module 3 and ensuring the stability of the display screen module 3.

It can be understood that, the first accommodating groove 22 may be slightly greater than the thickness of the display screen module 3 in a depth direction. Thus, when the thickness dimension of the display screen module 3 is slightly greater than a standard size, the display screen module 3 may still be fully inserted into the first accommodating groove 22, so that the cover plate 1 may fit with the support member 2.

In some other embodiments, the support member 2 may have a protruding portion in a direction of approaching the cover plate 1, the cover plate 1 is connected to the protruding portion on the support member 2, and an accommodating space may be formed between the cover plate 1 and one side of the support member 2 close to the cover plate 1. Thus, it may also provide an installation space for the display screen module 3.

In some embodiments, as shown in FIG. 1, the in-vehicle display apparatus 100 may further include a second adhesive layer 6, and the second adhesive layer 6 is disposed between the display screen module 3 and the cover plate 1, and one side of the second adhesive layer 6 is bonded to the display screen module 3 and another side of the second adhesive layer 6 is bonded to the cover plate 1. Thus, the workers may bond the display screen module 3 to the cover plate 1 through the second adhesive layer 6.

Exemplarily, the second adhesive layer 6 may be a liquid optically transparent adhesive layer. Thus, the second adhesive layer 6 has good adhesion, which may ensure the stability of the connection between the display screen module 3 and the cover plate 1. Meanwhile, the second adhesive layer 6 also has good light transmittance, which may ensure that users clearly view the graphic and text information displayed by the display screen module 3.

In some embodiments, the length of the second adhesive layer 6 may be less than or equal to the length of the display screen module 3, and the width of the second adhesive layer 6 may be less than or equal to the width of the display screen module 3. Thus, the second adhesive layer 6 does not extend to the peripheral side of the display screen module 3. Correspondingly, no adhesive structure needs to be disposed on the peripheral side of the display screen module 3, so that the workers may connect the second adhesive layer 6 to the display screen module 3.

In some embodiments, as shown in FIG. 3, one side of the support member 2 away from the cover plate 1 is provided with a connecting groove 231, and the backlight module 4 is inserted into the connecting groove 231. In the actual application process, after the backlight module 4 is inserted into the connecting groove 231, the peripheral wall of the connecting groove 231 may form a limitation on the backlight module 4, thereby ensuring the stability of the connection between the backlight module 4 and the support member 2.

In some embodiments, a limiting portion 232 is disposed within the connecting groove 231, and the backlight module 4 is detachably connected to the limiting portion 232. In the actual application process, the limiting portion 232 may form a limitation on the backlight module 4 so that the backlight module 4 may be stably disposed in the connecting groove 231.

Since the backlight module 4 is detachably connected to the limiting portion 232, when the backlight module 4 needs to be repaired or replaced, the workers may separate the backlight module 4 from the limiting portion 232 and take the backlight module 4 out of the connecting groove 231.

In order to achieve a detachable connection between the backlight module 4 and the limiting portion 232, in some embodiments, as shown in FIG. 4, FIG. 4 is a schematic diagram of a partial structure of an in-vehicle display apparatus 100, provided by the embodiments the present disclosure, the limiting portion 232 may be a limiting groove, and the limiting groove may be disposed on the peripheral wall of the connecting groove 231. The backlight module 4 may include a backlight module body 41 and a clamping portion 42. The backlight module body 41 is inserted into the connecting groove 231, and the clamping portion 42 is disposed on the peripheral side of the backlight module body 41 and is clamped in the limiting groove.

Thus, the detachable connection between the backlight module 4 and the limiting portion 232 may be achieved by the clamping portion 42 clamping in the limiting groove. In the actual application process, since the limiting groove is disposed on the peripheral wall of the connecting groove 231 and the clamping portion 42 is disposed on the peripheral side of the backlight module body 41, the disposing of the clamping portion 42 and the limiting groove do not increase the dimension of the in-vehicle display apparatus 100 in the thickness direction.

In some other embodiments, the limiting groove may be disposed on the bottom wall of the connecting groove 231, and correspondingly, the clamping portion 42 may be disposed on one side of the backlight module body 41 close to the bottom wall of the connecting groove 231. Thus, the clamping portion 42 may also be clamped in the limiting groove.

It can be understood that, the backlight module 4 may also be detachably connected to the limiting portion 232 in other ways. Exemplarily, the backlight module 4 may be adsorbed in the connecting groove 231 in a manner of magnetic attraction. Alternatively, the backlight module 4 may be fastened in the connecting groove 231 through screws.

The foregoing descriptions are merely specific implementations of the present disclosure, but the protection scope of the present disclosure is not limited thereto. Any change or replacement within the technical scope disclosed in the present disclosure shall be included in the protection scope of the present disclosure. Therefore, the protection scope of the present disclosure shall be determined based on the protection scope of the claims.

What is claimed is:

1. An in-vehicle display apparatus, wherein the in-vehicle display apparatus comprises:
a cover plate;
a support member, wherein the support member is located on one side of the cover plate;
a first adhesive layer, wherein the first adhesive layer is located between the cover plate and the support member, one side of the first adhesive layer is connected to the cover plate, and another side of the first adhesive layer is connected to the support member, an avoidance opening is disposed on the first adhesive layer, and the support member, the first adhesive layer and the cover plate enclose an accommodating space;
a display screen module, wherein the display screen module is disposed in the accommodating space and is only connected to the cover plate;
a backlight module, wherein the backlight module is connected to the support member, and is located on one side of the support member away from the display screen module; and
a rear cover, wherein the rear cover is connected to the support member.

2. The in-vehicle display apparatus according to claim 1, wherein a surface of one side of the support member close to the cover plate is provided with a first accommodating groove, and the display screen module is disposed in the first accommodating groove.

3. The in-vehicle display apparatus according to claim 1, wherein the in-vehicle display apparatus further comprises:
a second adhesive layer, wherein the second adhesive layer is disposed between the display screen module and the cover plate, and one side of the second adhesive layer is bonded to the display screen module and another side of the second adhesive layer is bonded to the cover plate.

4. The in-vehicle display apparatus according to claim 1, wherein
a length of the support member is greater than or equal to a length of the cover plate;
a width of the support member is greater than or equal to a width of the cover plate; or
a length of the support member is greater than or equal to a length of the cover plate and a width of the support member is greater than or equal to a width of the cover plate.

5. The in-vehicle display apparatus according to claim 1, wherein one side of the support member away from the cover plate is provided with a connecting groove, and the backlight module is inserted into the connecting groove.

6. The in-vehicle display apparatus according to claim 5, wherein a limiting portion is disposed within the connecting groove, and the backlight module is detachably connected to the limiting portion.

7. The in-vehicle display apparatus according to claim 6, wherein the limiting portion is a limiting groove, and the limiting groove is disposed on a peripheral wall of the connecting groove; and the backlight module comprises:
a backlight module body, wherein the backlight module body is inserted into the connecting groove; and
a clamping portion, wherein the clamping portion is disposed on a peripheral side of the backlight module and clamped with the limiting groove.

8. The in-vehicle display apparatus according to claim 1, wherein a protective cavity having an opening is disposed on the rear cover, and the backlight module is located on one side of the support member close to a bottom wall of the protective cavity.

9. The in-vehicle display apparatus according to claim 1, wherein
a connecting portion is disposed on the support member, an avoidance hole is disposed on the rear cover, and the in-vehicle display apparatus further comprises:
a mounting member, wherein the mounting member is penetrated through the avoidance hole, and one end of the mounting member is connected to the connecting portion and another end of the mounting member is connected to the rear cover.

10. The in-vehicle display apparatus according to claim 1, wherein a clamping member is disposed on the support member, a clamping groove is disposed on the rear cover, and the clamping member is clamped in the clamping groove.
